(19) United States
(12) Patent Application Publication
(10) Pub. No.: US 2019/0195002 A1
(43) Pub. Date: Jun. 27, 2019

(54) AWNING WINDOW ASSEMBLY HAVING A DOUBLE HUNG APPEARANCE

(71) Applicant: JELD-WEN, Inc., Klamath Falls, OR (US)

(72) Inventors: Gary Gardner, Redmond, OR (US); Kenneth Marcoulier, Redmond, OR (US); Kevin A. Campbell, Klamath Falls, OR (US); Bradley James Wirth, Klamath Falls, OR (US); Louis Levison, Klamath Falls, OR (US); Bryan Newpher, Ellicottville, NY (US)

(21) Appl. No.: 16/286,473

(22) Filed: Feb. 26, 2019

Related U.S. Application Data
(62) Division of application No. 15/224,277, filed on Jul. 29, 2016.
(60) Provisional application No. 62/199,894, filed on Jul. 31, 2015.

(51) Int. Cl. E06B 3/38; E06B 1/70; E06B 1/36

(52) U.S. Cl. CPC E06B 3/38; E06B 1/36; E06B 1/702

(57) ABSTRACT

A window assembly having a first sash and a second sash mounted to a window frame, the first and second sashes arranged along different vertical planes within the window frame to resemble the appearance of a double hung window. The window assembly further includes a hinge mechanism coupled to the window frame, the hinge mechanism operable to guide the first and second sashes away from the window frame to accommodate an outwardly swinging motion of the sashes in a similar fashion as a conventional awning window.

### RELATED APPLICATION DATA

This application is a divisional of and claims the benefit under 35 U.S.C. § 120 from U.S. patent application Ser. No. 15/224,277, filed Jul. 29, 2016, which is a nonprovisional of and claims the benefit under 35 U.S.C. § 119(e) of U.S. Provisional Patent Application No. 62/199,894, filed Jul. 31, 2015, the disclosures of which are incorporated by reference herein in their entireties.

### TECHNICAL FIELD

The field of the present disclosure relates generally to windows, and in particular, to a window assembly having an appearance of a double hung window with a sash that swings outwardly and operates like an awning window.

### BACKGROUND

A conventional double hung window includes an upper sash and a lower sash arranged along two different vertical planes within a window frame. In operation, one or both sashes are slidable upwardly and downwardly within the window frame to open and close the window. A conventional awning window includes a sash that is hinged at the top to allow the sash to swing outwardly away from the window frame to an open configuration. Typically, awning windows are opened and closed via operation of a lever operator or window crank, thereby requiring less force to operate as compared to a sliding double hung window that may require lifting one or both sashes. Accordingly, awning windows may be more desirable than double hung windows in certain settings, such as homes where children, disabled, or elderly residents may be present, because operation of the awning windows is typically less demanding.

Double hung windows are commonly found in older homes, and when renovations are required, such as to satisfy modern building and fire codes or to repair a damaged window, owners must choose between retaining the original aesthetic of the double hung window or opting for the advantages of an awning window. In certain instances, such as for historic buildings, retaining the original aesthetic of the double hung window may be required. Accordingly, the present inventors have determined that it would be desirable to have a modified window structure that provides the aesthetics of an authentic double hung window, while also having the functionality and ease of use of an awning window. Additional aspects and advantages of such a window will be apparent from the following detailed description of example embodiments, which proceed with reference to the accompanying drawings.

Understanding that the drawings depict only certain embodiments and are not, therefore, to be considered limiting in nature, these embodiments will be described and explained with additional specificity and detail with reference to the drawings.

### BRIEF DESCRIPTION OF THE DRAWINGS

FIG. 1 illustrates an example window assembly with an upper sash and an outwardly swinging lower sash, according to one embodiment.

FIG. 2 illustrates a hinge mechanism for accommodating the swinging motion of the lower sash of the window assembly of FIG. 1.

FIG. 3 is a side view of the window assembly of FIG. 1 in a closed configuration.

FIG. 3A is an enlarged view of the window assembly of FIG. 3 illustrating additional detail of the meeting rails of the upper and lower sashes.

FIG. 4 is a side view of the window assembly of FIG. 1 in a partially open configuration.

FIG. 4A is an enlarged view of the window assembly of FIG. 4 illustrating additional detail of the meeting rails of the upper and lower sashes.

FIG. 5 is a side view of the window assembly of FIG. 1 in an open configuration.

FIG. 5A is an enlarged view of the window assembly of FIG. 5 illustrating additional detail of the meeting rails of the upper and lower sashes.

FIG. 6 is a side view illustrating a sequence of movement of the lower sash of the window assembly of FIG. 1.

FIGS. 7 and 8 illustrate an example window assembly with unified upper and lower sashes both movable in an outwardly swinging fashion, according to one embodiment.

### DETAILED DESCRIPTION OF DISCLOSED EMBODIMENTS

With reference to the drawings, this section describes particular embodiments and their detailed construction and operation. The embodiments described herein are set forth by way of illustration only and not limitation. The described features, structures, characteristics, and methods of operation may be combined in any suitable manner in one or more embodiments. In view of the disclosure herein, those skilled in the art will recognize that the various embodiments can be practiced without one or more of the specific details or with other methods, components, materials, or the like. In other instances, well-known structures, materials, or methods of operation are not shown or not described in detail to avoid obscuring more pertinent aspects of the embodiments.

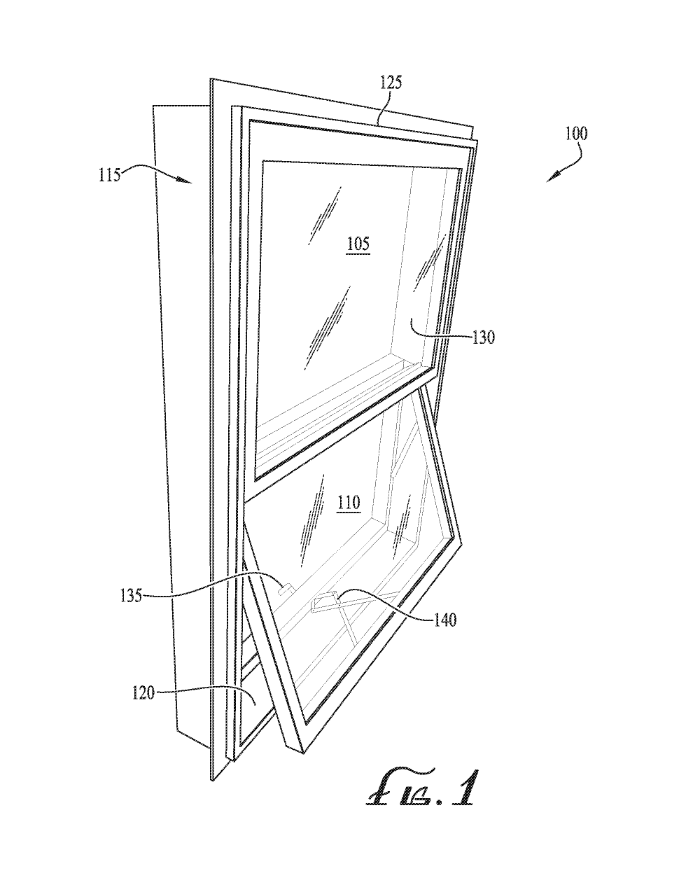

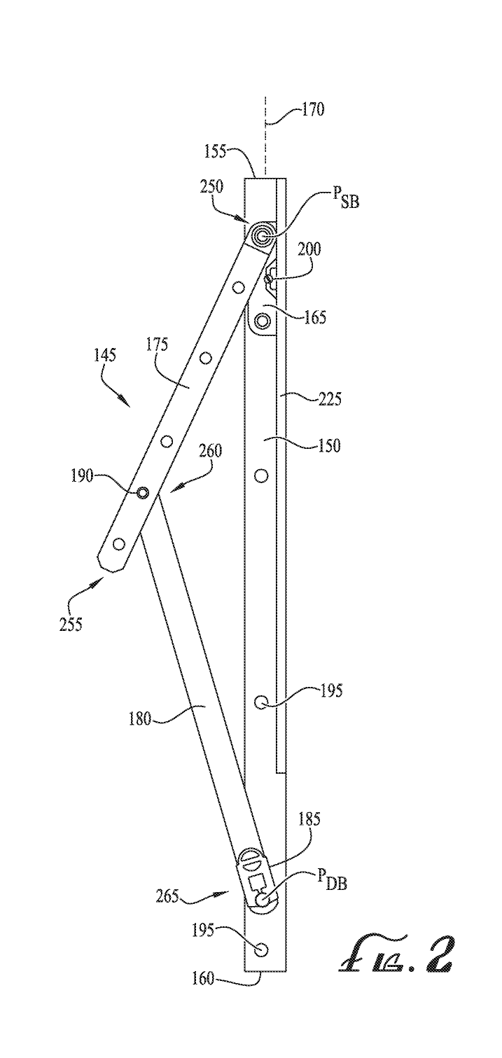

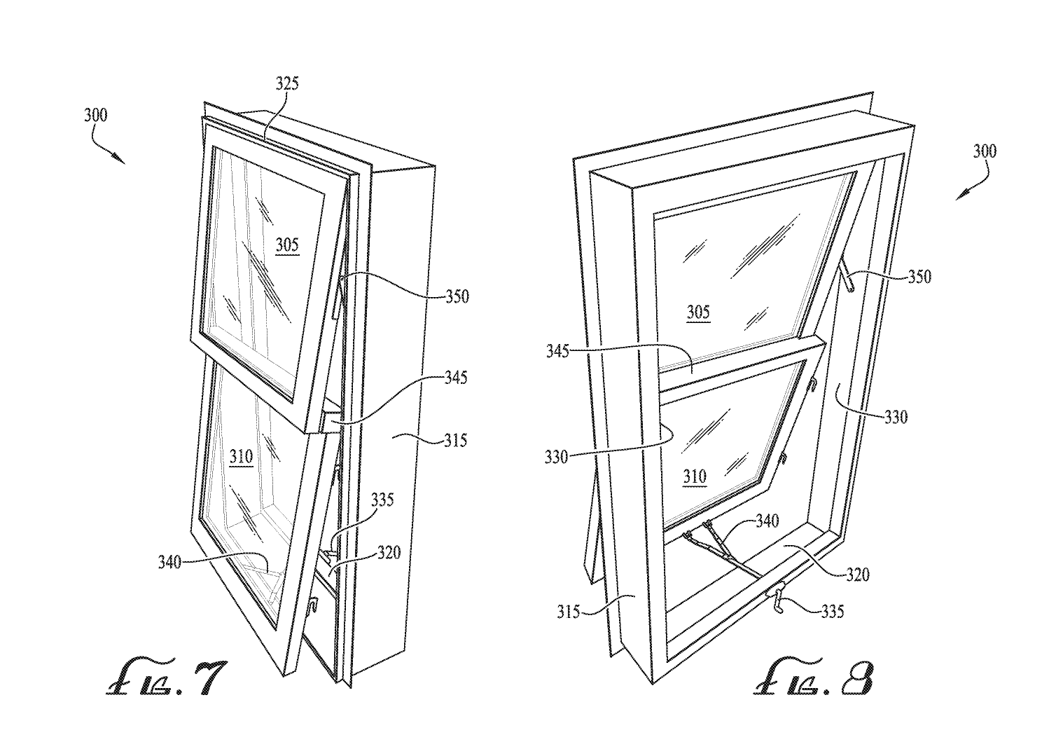

FIGS. 1-8 collectively illustrate various embodiments of a window assembly 100, 300. In window assembly 100 illustrated in FIGS. 1-6, the window assembly 100 includes an upper sash 105 and a lower sash 110 offset from one another and arranged to resemble a conventional double hung window as is discussed in further detail below with reference to the figures. In some embodiments, the upper sash 105 may be fixed, that is, the upper sash 105 may not be slidable or otherwise moveable within the window frame 115. A hinge mechanism 145 (see FIG. 2) is mounted to an interior surface of each of the jambs 130 and coupled to the lower sash 110. The hinge mechanism 145 accommodates a swinging motion of the lower sash 110, which may be a similar motion to that of a conventional awning window. The action and arrangement of the hinge mechanism 145 provides sufficient clearance to allow the lower sash 110 to swing outwardly while not interfering with the fixed upper sash 105. In other embodiments (not shown), the upper sash 105 may not be fixed but may instead be slidable within the window frame 115 and relative to the lower sash 110 for ventilation or cleaning without interfering with the lower sash 110. In the window assembly of FIGS. 7-8, the window assembly 300 includes an upper sash 305 and a lower sash 310, where the sashes 305, 310 are unified at a meeting rail 345 such that both the upper and lower sashes 305, 310 jointly swing inwardly or outwardly as described in further detail below. The following sections describe additional details of the functionality of the hinge mechanism and other components of the window assemblies 100, 300.

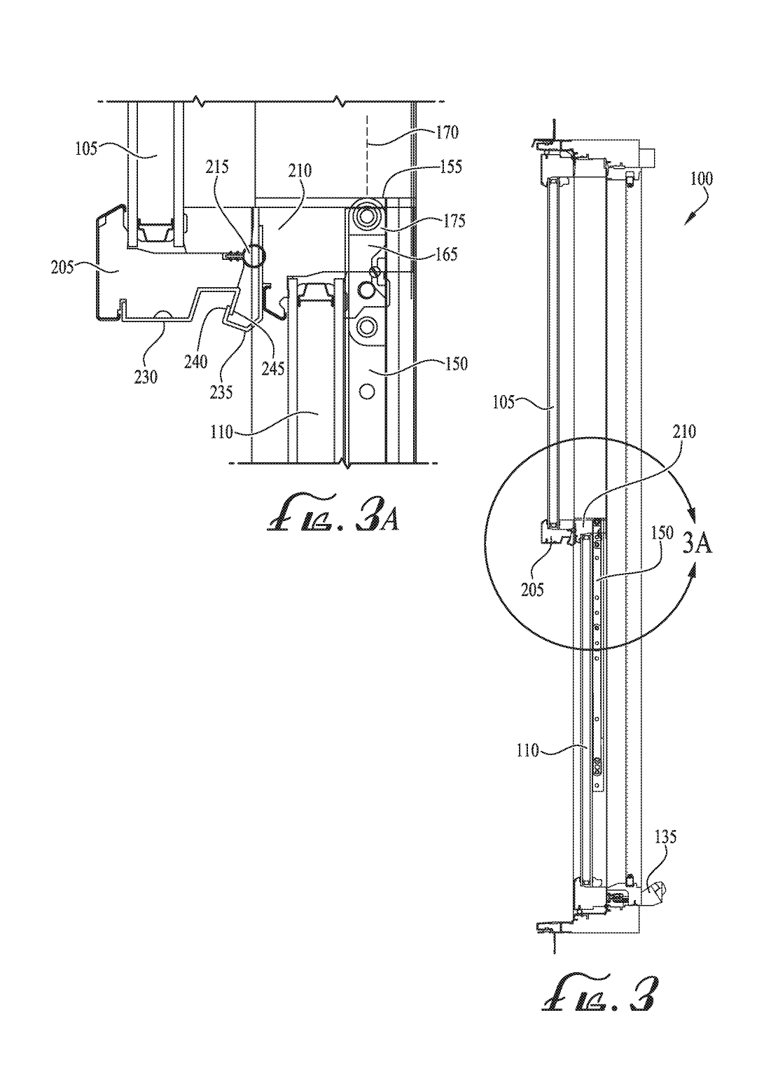

With particular reference to FIG. 1, the window assembly 100 includes a frame 115 adapted to be secured within an opening of a building or housing structure. The frame 115 includes a sill 120 and a header 125, each of which extending horizontally and connected at their respective ends by a pair of vertically extending jambs 130. Upper sash 105 is positioned adjacent the header 125 between an upper portion of the jambs 130, and the lower sash 110 is positioned adjacent the sill 120 between a lower portion of the jambs 130. As mentioned previously, the upper sash 105 is arranged along a first vertical plane and the lower sash 110 is arranged along a second vertical plane offset inwardly (relative to the building) so that the window assembly 100 resembles a conventional double hung window (see FIG. 3), with the lower sash 110 extending generally downwardly relative to the upper sash 105. In the illustrated embodiment, the upper sash 105 is positioned outwardly of the lower sash 110 and overlapping the meeting rail of the lower sash (when closed) when the window assembly 100 is viewed from an exterior of the building.

The window assembly 100 includes a window crank 135 (or other suitable operator device) attached along an interior portion of the sill 120. The window crank 135 is operably associated with an extendable connecting arm(s) 140 attached to the lower sash 110, where the connecting arm 140 may include one or more individual arms. When the window crank 135 is operated, at least a portion of the connecting arm(s) 140 extends outwardly from the window frame 115 and moves the lower sash 110 from its closed configuration toward an open configuration. To close the lower sash 110, the window crank 135 may be operated to retract the connecting arm 140 and move the lower sash 110 toward the window frame 115. In some embodiments, the window crank 135 may require fewer than 5 pounds of force to open the lower sash 110.

In some embodiments, the lower sash 110 opens outwardly at an angle of at least 45 degrees, and may be up to 75 degrees relative to its vertical plane (e.g., when in the closed configuration). In other embodiments, the lower sash 110 may open at an angle ranging from 0 degrees to 60 degrees or less. In some embodiments, the angle of the lower sash 110 may be sufficiently large so as to provide an easy egress means through which people may leave a structure, such as during an emergency. As mentioned previously, when the lower sash 110 swings outwardly, a hinge mechanism 145 accommodates the swinging motion and allows the lower sash 110 to move outwardly without interfering with the fixed upper sash 105. The following describes additional details of the hinge mechanism 145 and its operation.

FIG. 2 illustrates an example embodiment of a hinge mechanism 145 operable to support the swinging motion of the lower sash 110. While the following section proceeds with description of a single hinge mechanism 145, it should be understood that the window assembly 100 may include a pair of hinge mechanisms 145, each one attached to a corresponding jamb 130 of the window frame 115 and supporting the lower sash 110.

With reference to FIG. 2, the hinge mechanism 145 includes a vertically elongate base plate 150 attached to jamb 130, the base plate 150 having a first end 155 and an opposite second end 160. The base plate 150 supports a shoe 165 adjacent the first end 155, and includes a track 225 against which the shoe 165 sits. The track 225 provides a guideway for the shoe 165 and accommodates a sliding movement of the shoe 165 along a vertical axis 170 as discussed in further detail below.

The hinge mechanism 145 further includes a sash bar 175 having a first end 250 and an opposite second end 255. The sash bar 175 is pivotably supported adjacent its first end 250 on an upper portion of the shoe 165. A detachment bar 180 is pivotably coupled along a first end 260 to the sash bar 175 at an attachment point 190 along the second end 255 of the sash bar 175. In some embodiments, the detachment bar 180 may be riveted, welded, screwed, or otherwise coupled with the sash bar 175 using other suitable fastening means. Along a second end 265, the detachment bar 180 is pivotably connected to the base plate 150 via a clip 185 inserted into openings 195 formed adjacent the second end 160 of the base plate 150.

In some embodiments, the hinge mechanism 145 may include an adjustment screw 200 coupled to the shoe 165. The adjustment screw 200 may be used to adjust the frictional contact between the shoe 165 and the base plate 150 to control the sliding motion of the shoe 165. For example, the adjustment screw 200 may be loosened to reduce the friction between the shoe 165 and the base plate 160 to promote an easier sliding movement of the shoe 165.

The base plate 150 includes a plurality of attachment points 195, typically holes or openings, to accommodate installation in one of several different connection positions for the detachment bar 180. The sash bar 175 and the detachment bar 180 (along with the connecting arm 140 shown in FIG. 1) cooperate to collectively support operation of the lower sash 110 when the lower sash 110 is swung outwardly in an open configuration. As is further described in detail below with particular reference to FIGS. 3-5, the pivot point P_{DB} of the detachment bar 180 is fixed relative to the base plate 150, but the pivot point P_{SB} of the sash bar 175 changes along with movement of the shoe 165 to help accommodate the swinging movement of the lower sash 110.

Collectively, FIGS. 3-5 illustrate additional details regarding an example operation of the hinge mechanism 145 and its role in supporting the swinging motion of the lower sash 110. FIG. 3 illustrates the window assembly 100 in a closed configuration and FIG. 3A illustrates an enlarged view of the check rails 205, 210 (also known as meeting rails) of the upper and lower sashes 105, 110, respectively. With reference to the enlarged view of FIG. 3A, in the closed configuration, the check rail 205 of the upper sash 105 and the check rail 210 of the lower sash 110 are adjacent one another and together seal the window assembly 100. The check rails 205, 210 each include a snubber 230, 235 respectively carried thereon. In one embodiment, the snubbers 230, 235 are aluminum extrusions including ends 240, 245 that engage or interlock between the check rails 205, 210 when the window assembly 100 is closed. The interlocking snubbers 230, 235 help strengthen the window assembly 100 for impact resistance.

In one embodiment, the check rail 205 of the upper sash 105 includes a foam-filled bulb weatherstrip 215 (or any other suitable seal) extending inwardly therefrom toward the lower sash 110, with the bulbous portion of the weatherstrip 215 abutting the check rail 210 of the lower sash 110, when closed, to help maintain an appropriately sealed environment. As illustrated in FIGS. 3 and 3A, when the window assembly 100 is in the closed configuration, the sash bar 175 and the detachment bar 180 are each aligned along the vertical axis 170 of the base plate 150, with the shoe 165 and the sash bar 175 positioned adjacent the top end 155 of the base plate 150.

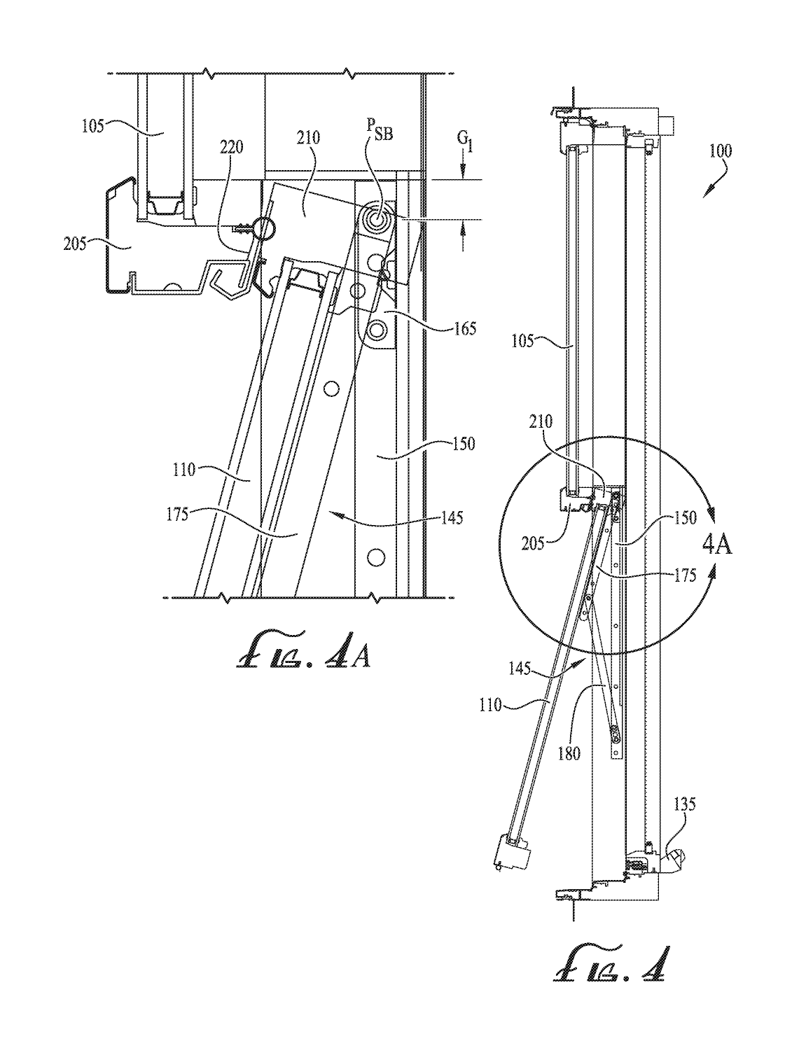

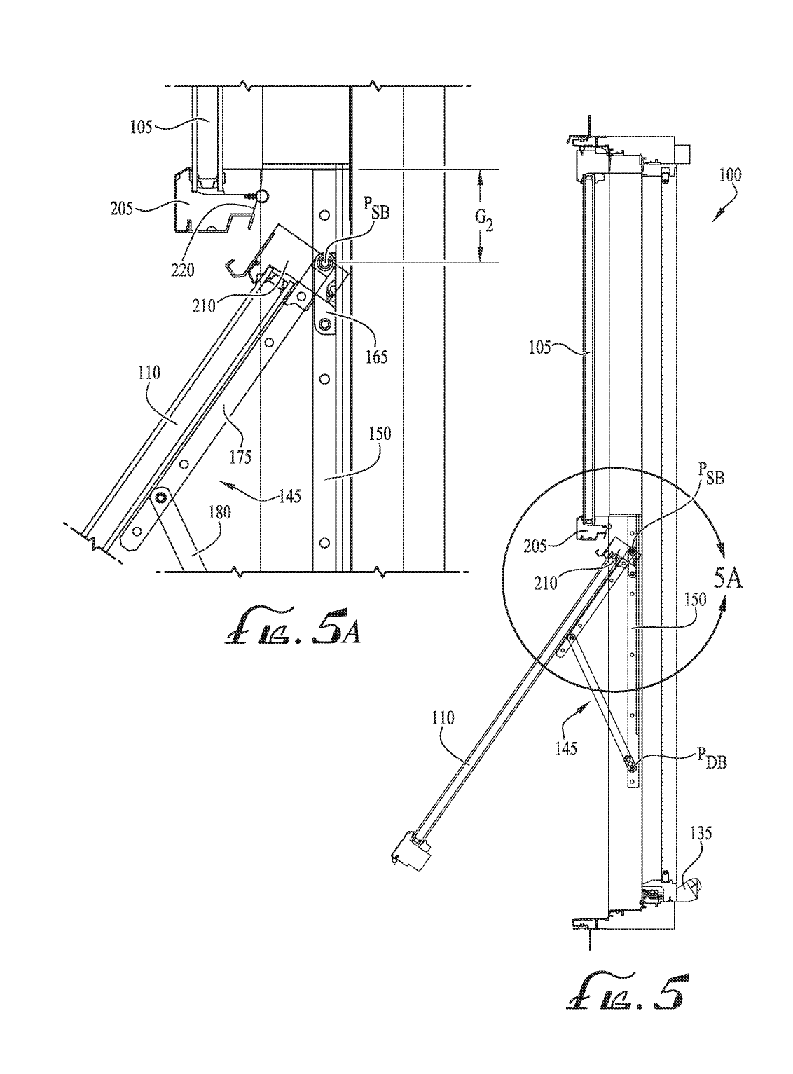

FIGS. 4 and 4A illustrate the window assembly 100 in a partially open configuration, according to one embodiment. With particular reference to FIG. 4A, as the lower sash 110 is opened and swung outwardly via operation of the window crank 135, the shoe 165 slides downwardly on the base plate 150 along the vertical axis 170 toward the second end 160 of the base plate 150. As the shoe 165 moves downwardly so does the pivot point P_{SB} of the sash bar 175 as represented by the gap G₁ relative to the first end 155 of the base plate 150. As illustrated in FIG. 4A, the downwardly sliding motion of the shoe 165 provides sufficient clearance for the check rail 210 of the lower sash 110 to clear the check rail 205 of the upper sash 105. In some embodiments, the check rail 205 may include a beveled or chamfered inside wall 220 (best illustrated in FIG. 5A) to provide additional relief to ensure that the check rail 210 avoids contacting the check rail 205 when the lower sash 110 is opened. Unlike conventional double-hung sliding windows, the inside wall 220 is beveled outwardly at its lower edge, rather than at its upper edge.

FIGS. 5 and 5A illustrate the window assembly 100 in a fully open configuration, according to one embodiment. As mentioned previously, when the lower sash 110 is opened, the shoe 165 slides downwardly along the vertical axis 170, thereby moving the pivot point P_{SB} of the sash bar 175 downwardly toward the second end 160 of the base plate 150. When the window assembly 100 is fully open, the pivot point P_{SB} slides further down along the base plate 150 and is separated by a gap G₂ from the first end 155 of the base plate 150, where the gap G₂ is greater than the gap G₁. In this fashion, the sliding shoe 165 accommodates the swinging movement of the lower sash 110 and ensures that the check rails 205, 210 do not interfere with one another to allow the window assembly 100 to operate in a similar fashion as an awning window while maintaining the appearance of a double hung window.

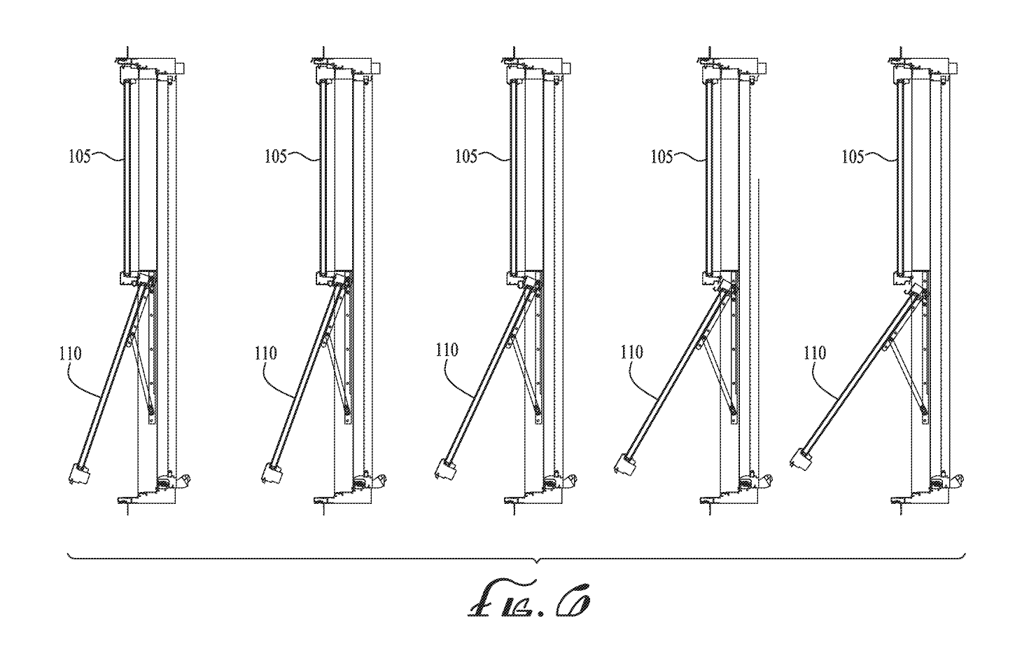

FIG. 6 is a side view illustrating a sequence of movement of the lower sash 110 of the window assembly of FIG. 1. As illustrated in FIG. 6, as the lower sash 110 is opened further and away from the window frame 115, the shoe 165 slides downwardly toward the second end 160 of the base plate 150 to ensure that sufficient separation is maintained between the check rails 205, 210 at all times. As the shoe 165 slides downwardly, the pivot point P_{SB} of the sash bar 175 changes along with movement of the shoe 165 whereas the pivot point P_{DB} of the detachment bar 180 remains fixed to help accommodate the swinging movement of the lower sash 110. As the lower sash 110 is opened, both the sash bar 175 and the detachment bar 180 move outwardly away from the window frame 115. When the window is returned back to a closed configuration, both the sash bar 175 and the detachment bar 180 move toward vertical alignment with the base plate 150, and the shoe 165 slides upwardly along the vertical axis 170 toward the first end 155 of the base plate 150.

As mentioned previously, FIGS. 1-6 illustrate an embodiment for a window assembly 100 where the lower sash 110 swings outwardly like an awning window and the upper sash 105 is either fixed in position or is slidable upwardly/downwardly within the window frame 115 while the lower sash 110 is closed. In other embodiments, the window assembly may be configured in different arrangements to provide the appearance of a double hung window with the functionality of hopper and/or awning windows, certain of which are briefly described below.

For example, in one embodiment, the window assembly may be arranged to resemble a double hung window with an upper sash and a hopper lower sash that is hinged at the bottom near the sill to accommodate the outward swinging motion of the lower sash. In such embodiment, the planes of the upper and lower sashes may be reversed from the example embodiment illustrated in FIG. 1, with the upper sash arranged in the interior position along the plane where the lower sash 110 is arranged in FIG. 1, and the lower sash arranged in the exterior position along the plane where the upper sash 105 is arranged in FIG. 1. Such arrangement allows the lower sash to swing outwardly without interfering with the meeting rail. In some embodiments, the upper sash may be fixed in position within the window frame. Alternatively, the upper sash may be slidable upwardly or downwardly within the window frame.

In another embodiment, the window assembly may include an upper and lower sash arranged in a stacked configuration similar to a double hung window. The upper sash may be hinged at the top to accommodate an outward swinging motion similar to an awning window. Alternatively, the upper sash may be hinged near the meeting rail between the sashes to accommodate an outward swinging motion similar to a hopper window. For each of these embodiments, the lower sash may be fixed in position or may instead be slidable upwardly or downwardly within the window frame. Accordingly, the window assembly would resemble a double hung window but with an outwardly movable upper sash frame.

FIGS. 7-8 illustrate another embodiment of a window assembly 300. With reference to FIGS. 7-8, window assembly 300 includes an upper sash 305 and a lower sash 310 offset from one another and arranged to resemble a conventional double hung window. The window assembly 300 further includes a window frame 315 adapted to be secured within an opening of a building or housing structure. The frame 315 includes a sill 320 and a header 325, each of which extending horizontally and connected at their respective ends by a pair of vertically extending jambs 330. Upper sash 305 is positioned adjacent the header 325 between an upper portion of the jambs 330, and the lower sash 310 is positioned adjacent the sill 320 between a lower portion of the jambs 330. As mentioned previously, the upper sash 305 is arranged along a first vertical plane and the lower sash 310 is arranged along a second vertical plane offset inwardly (relative to the building) resembling a conventional double hung window.

The upper and lower sashes 305, 310 are joined to one another by a meeting rail 345 positioned between the sashes 305, 310 at a general midpoint of the window assembly 300. As the meeting rail 345 joins the sashes 305, 310 to one another, the meeting rail 345 urges joint movement of the sashes 305, 310 as a single, unified unit, thereby allowing the sashes 305, 310 to open and close together, but are not otherwise movable independently from one another as is further described in detail below.

At the meeting rail 345, the window assembly 300 may include a sealing system similar to the one described with reference to FIG. 3 for window assembly 100. For example, the window assembly 300 may include a foam-filled bulb weatherstrip or any other suitable seal (not shown) to help maintain an appropriately sealed environment.

The window assembly 300 includes a window crank 335 (or other suitable operator device) attached along an interior portion of the sill 320. The window crank 335 is operably associated with an extendable connecting arm 340 attached to the lower sash 310. When the window crank 335 is operated, the connecting arm 340 extends outwardly from the window frame 315 and moves the lower sash 310 from its closed configuration toward an open configuration. As the lower sash 310 moves outwardly, the upper sash 305 also pivots outwardly due to the joining of the sashes 305, 310 at the meeting rail 345. To accommodate the swinging motion of the sashes 305, 310, the window assembly 300 include a hinge assembly 350 of a similar construction and operation commonly used with awning windows. The hinge 350 is positioned adjacent the header 325 of the window frame to allow the upper sash 305 to swing outwardly as the crank 335 is operated and the connecting arm 340 extends outwardly. To close the sashes 305, 310, the window crank 335 may be operated to retract the connecting arm 340 and move the sashes 305, 310 toward the window frame 315.

It is intended that subject matter disclosed in any one portion herein can be combined with the subject matter of one or more other portions herein as long as such combinations are not mutually exclusive or inoperable. In addition, many variations, enhancements and modifications of the concepts described herein are possible.

The terms and descriptions used above are set forth by way of illustration only and are not meant as limitations. Those skilled in the art will recognize that many variations can be made to the details of the above-described embodiments without departing from the underlying principles of the invention.

1-12. (canceled)

13. A window assembly comprising:
a window frame including a first elongate jamb and a parallel second elongate jamb, the window frame further including a sill extending horizontally between the jambs along a lower portion thereof, and a header extending horizontally between the jambs along an upper portion thereof;
a first sash mounted between the jambs, the first sash including an upper portion positioned proximal the header of the window frame, the first sash positioned along a first vertical plane within the window frame;
a second sash mounted between the jambs, the second sash including a lower portion positioned proximal the sill of the window frame, the second sash positioned generally underneath the first sash and along a second vertical plane within the window frame, the second vertical plane being offset from the first vertical plane of the first sash; and
a rail, wherein the first and second sashes are each coupled to the rail, and wherein the first and second sashes are jointly movable outwardly in a swinging motion relative to the window frame from a closed configuration to an open configuration.

14. The window assembly of claim 13, further including a hinge mechanism arranged adjacent the header of the window frame, the hinge mechanism coupled to the first sash and operable to support movement of the first and second sashes from the closed configuration to the open configuration.

15. The window assembly of claim 13, further comprising an operator device attached to the window frame and attached to the second sash, wherein the operator device is operable to move the first and second sashes between the closed configuration and the open configuration.

16. The window assembly of claim 13, the rail further including one or more weatherstrips operable to maintain a sealed environment for the window assembly.

17. The window assembly of claim 15, wherein the operator device further includes one or more arms attached to the second sash, wherein the operator device is operable to extend the one or more arms relative to the window frame to move the first and second sashes from the closed configuration to the open configuration.

18. The window assembly of claim 17, wherein the operator device is further operable to retract the one or more arms to move the first and second sashes from the open configuration to the closed configuration.

19. The window assembly of claim 13, wherein the first sash is immovable along the first vertical plane within the window frame and the second sash is immovable along the second vertical plane within the window frame.

20. The window assembly of claim 13, wherein the first sash and second sash are immovable relative to one another.

21. The window assembly of claim 13, wherein a lower portion of the first sash is attached to the rail and an upper portion of the second sash is attached to the rail.

22. The window assembly of claim 13, wherein the first and second sashes are movable outwardly in a swinging motion such that the second sash is arranged at an angle of up to 75 degrees relative to the second vertical plane.

23. The window assembly of claim 13, wherein the first and second sashes are movable outwardly in a swinging motion such that the second sash is movable between an angle ranging from 0 degrees to 60 degrees relative to the second vertical plane.

24. The window assembly of claim 13, wherein the first and second sashes are movable outwardly in a swinging motion such that the second sash is movable between an angle ranging from 45 degrees to 75 degrees relative to the second vertical plane.
